(19) United States
(12) Patent Application Publication
(10) Pub. No.: US 2025/0023280 A1
(43) Pub. Date: Jan. 16, 2025

(54) CONNECTOR MANUFACTURING METHOD AND CONNECTOR

(71) Applicant: Japan Aviation Electronics Industry, Limited, Tokyo (JP)

(72) Inventor: Osamu HASHIGUCHI, Tokyo (JP)

(73) Assignee: Japan Aviation Electronics Industry, Limited, Tokyo (JP)

(21) Appl. No.: 18/672,189

(22) Filed: May 23, 2024

(30) Foreign Application Priority Data
Jul. 13, 2023 (JP) 2023-114850

(51) Int. Cl. H01R 13/422; H01R 12/71; H01R 43/20

(52) U.S. Cl. CPC H01R 13/422; H01R 12/716; H01R 43/20

(57) ABSTRACT

A method for manufacturing a connector comprises providing a housing and a contact intermediate product, making the holding portion of the housing hold a held portion of the contact intermediate product to attach the contact intermediate product to the housing, and inserting a jig between a contact point and the held portion to deform the contact intermediate product plastically and thereby forming a contact. The contact intermediate product does not enter an allowing portion in a state where it is attached to the housing. After the plastically deformation, a tip portion is situated in the allowing portion, and it is hidden by a movement suppression portion at least in part when viewed along an up-down direction.

### CROSS REFERENCE TO RELATED APPLICATIONS

This application is based on and claims priority under 35 U.S.C. § 119 to Japanese Patent Application No. JP2023-114850 filed Jul. 13, 2023, the contents of which are incorporated herein in their entirety by reference.

### BACKGROUND OF THE INVENTION

This invention relates to a connector manufacturing method and a connector.

JP 2011-65802 A (Patent Document 1) discloses an example of a stacking connector which is used for electrical connection between wiring boards.

As shown in FIG. 19, the stacking connector of Patent Document 1 is provided with a socket housing 90 and a plurality of socket contacts 92. The socket housing 90 is formed with recess portions 901 for receiving the socket contacts in part. Moreover, the socket housing 90 is provided with overhangs (movement suppression portions) 903 for suppressing movement of the socket contacts 92 when the socket contacts 92 and plug contacts (not shown) are mated with or departed from each other. Furthermore, the socket housing 90 is provided with a bottom portion (deformation prevention portion) 905 for preventing the socket contacts 92 from being deformed so that the socket contacts are not brought into contact with a wiring board (not shown).

As understood from FIG. 20, in a manufacturing process of the stacking connector of Patent Document 1, attachment of the socket contacts 92 to the socket housing 90 is carried out by using a first jig 94 and a second jig 96. Resilient deformation of the socket contacts 92 that is carried out by using the first jig 94 and the second jig 96 allows the socket contacts 92 to be introduced into the recess portions 902 of the socket housing 90. After that, upon taking away the first jig 94 and the second jig 96, the socket contacts 92 return to their original shapes owing to reaction forces. Thus, contact points 921 and facing portions 923 of the socket contacts 92 face each other at predetermined intervals, respectively.

### SUMMARY OF THE INVENTION

The manufacturing method of Patent Document 1 presupposes that the socket contact 92 is not plastically deformed. In other words, the socket contact 92 must have an elastic limit where it is not plastically deformed during the manufacturing process. However, an elastic limit of a contact decreases as the contact is downsized. Accordingly, the method of Patent Document 1 has a possibility that the socket contact 92 is plastically deformed so that an interval between the contact point 921 and the facing portion 923 becomes narrower than the predetermined interval in a case where the connector is downsized. If the interval between the contact point 921 and the facing portion 923 is narrower than the predetermined interval, the socket contact 92 may be buckled and become impossible to mate with the plug contact (not shown) when attempting to mate the socket contact 92 with the plug contact.

It is therefore an object of the present invention to provide a method for manufacturing a connector having structure which has a housing provided with a movement suppression portion and a deformation prevention portion and which enables the connector to be downsized.

In addition, it is another object of the present invention to provide a connector having the aforementioned structure.

One aspect of the present invention provides a method for manufacturing a connector which is mateable with a mating connector positioned upward of the connector in an up-down direction. The method comprises preparing a housing and a contact intermediate product. The housing has a holding portion, a bottom portion and a movement suppression portion. The housing is formed with a receiving portion which is situated upward of the bottom portion and opens upward and an allowing portion communicating with the receiving portion in a lateral direction perpendicular to the up-down direction. The movement suppression portion extends toward the receiving portion over the allowing portion. The contact intermediate product has a held portion, a lower end portion extending from the held portion, a bent portion provided at one end of the lower end portion, a supporting portion extending from the bent portion, a contact point supported by the supporting portion and a tip portion extending from the contact point. The contact point faces a facing portion provided on the held portion in the lateral direction. The method further comprises making the holding portion of the housing hold the held portion of the contact intermediate product to attach the contact intermediate product to the housing. In a state where the contact intermediate product is attached to the housing, the contact intermediate product does not enter the allowing portion. The method further comprises inserting a jig between the contact point and the facing portion of the held portion and thereby causing plastic deformation of the contact intermediate product to form a contact. After the plastic deformation, the tip portion is situated in the allowing portion at least in part and hidden by the movement suppression portion at least in part when viewed along the up-down direction.

Another aspect of the present invention provides a connector which is mateable with a mating connector positioned upward of the connector in an up-down direction. The connector comprises a housing and a contact. The housing has a holding portion, a bottom portion and a movement suppression portion. The housing is formed with a receiving portion which is situated upward of the bottom portion and opens upward and an allowing portion communicating with the receiving portion in a lateral direction perpendicular to the up-down direction. The movement suppression portion extends toward the receiving portion over the allowing portion. The contact has a held portion, a lower end portion extending from the held portion, a bent portion provided at one end of the lower end portion, a supporting portion extending from the bent portion, a contact point supported by the supporting portion and a tip portion extending from the contact point. The held portion is held by the holding portion. The lower end portion and the bent portion are situated in the receiving portion. The tip portion is situated in the allowing portion at least in part and hidden by the movement suppression portion at least in part when viewed along the up-down direction.

In the method for manufacturing the connector according to the aforementioned aspect of the present invention, the contact is formed by plastic deformation of the contact intermediate product after attachment of the contact intermediate product to the housing. According to the method, when the contact intermediate product is attached to the housing, it is unnecessary intentionally to deform the contact intermediate product resiliently. Thus, the contact can be downsized because it does not need a high elastic limit, so that the connector can be downsized.

In the connector according to the aforementioned other aspect of the present invention, the lower end portion and the bent portion of the contact are situated in the receiving portion of the housing. On the other hand, the tip portion of the contact is positioned in the allowing portion at least in part and hidden by the movement suppression portion at least in part when the connector is viewed along the up-down direction. With this structure, when the connector and the mating connector are mated with or detached from each other, movement of the contact is regulated, and buckling of the contact is prevented. Moreover, the receiving portion is situated upward of the bottom portion, so that the bottom portion prevents the contact partly received by the receiving portion from being deformed.

An appreciation of the objectives of the present invention and a more complete understanding of its structure may be had by studying the following description of the preferred embodiment and by referring to the accompanying drawings.

### BRIEF DESCRIPTION OF THE DRAWINGS

FIG. 1 is a perspective view showing a connector according to a first embodiment of the present invention.

FIG. 2 is a top view showing the connector of FIG. 1.

FIG. 3 is a bottom view showing the connector of FIG. 1.

FIG. 4 is a front view showing the connector of FIG. 1.

FIG. 5 is a side view showing the connector of FIG. 1.

FIG. 6 is a cross-sectional view showing the connector of FIG. 5, taken along line A-A.

FIG. 7 is a perspective view showing a mating connector which is mateable with the connector of FIG. 1.

FIG. 8 is a perspective view showing a connector assembly which consists of the connector of FIG. 1 and the mating connector of FIG. 7. The connector and the mating connector are mated with each other.

FIG. 9 is a side view showing the connector assembly of FIG. 8.

FIG. 10 is a cross-sectional view showing the connector assembly of FIG. 9, taken along line B-B.

FIG. 11 is a perspective view showing a jig which is used for manufacturing the connector of FIG. 1.

FIG. 12 is a side view for describing a step of a manufacturing process for manufacturing the connector of FIG. 1, wherein the jig of FIG. 11 is used. The jig is positioned upward of the connector intermediate product.

FIG. 13 is a cross-sectional view showing the jig and the connector intermediate product of FIG. 12, taken along C-C line.

FIG. 14 is a side view for describing a step following the step of FIG. 12. An insert portion of the jig is inserted into a receiving portion of the connector intermediate product.

FIG. 15 is a cross-sectional view showing the jig and the connector intermediate product of FIG. 14, taken along line D-D.

FIG. 16 is a bottom view showing a connector according to a second embodiment of the present invention.

FIG. 17 is a side view showing the connector of FIG. 16.

FIG. 18 is a cross-sectional view showing the connector of FIG. 17, taken along line E-E.

FIG. 19 is a cross-sectional view showing a socket housing and socket contacts which are included in a stacking connector disclosed in Patent Document 1.

FIG. 20 is a cross-sectional view for describing an attaching method of the socket contacts to the socket housing of FIG. 19.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

### First Embodiment

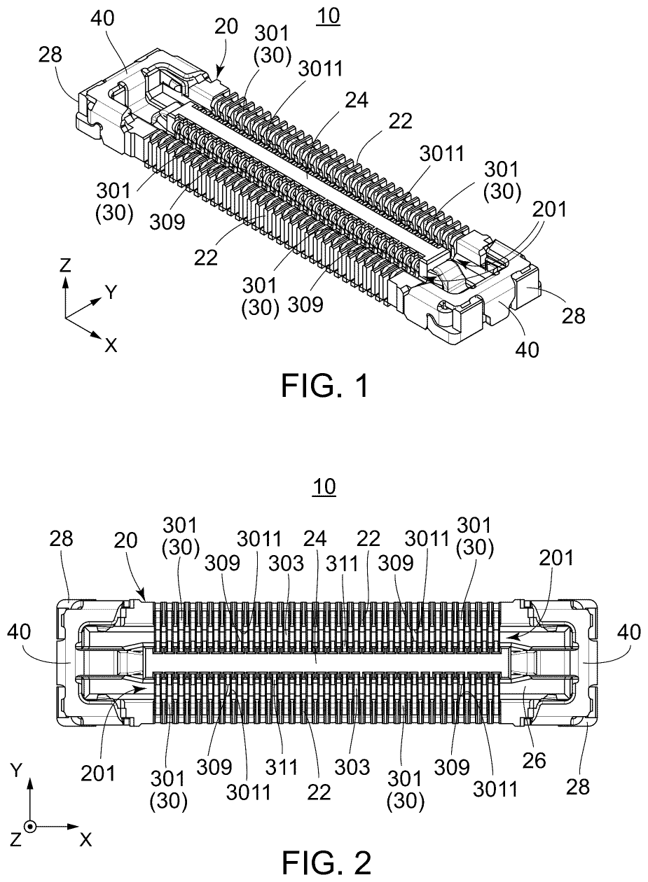

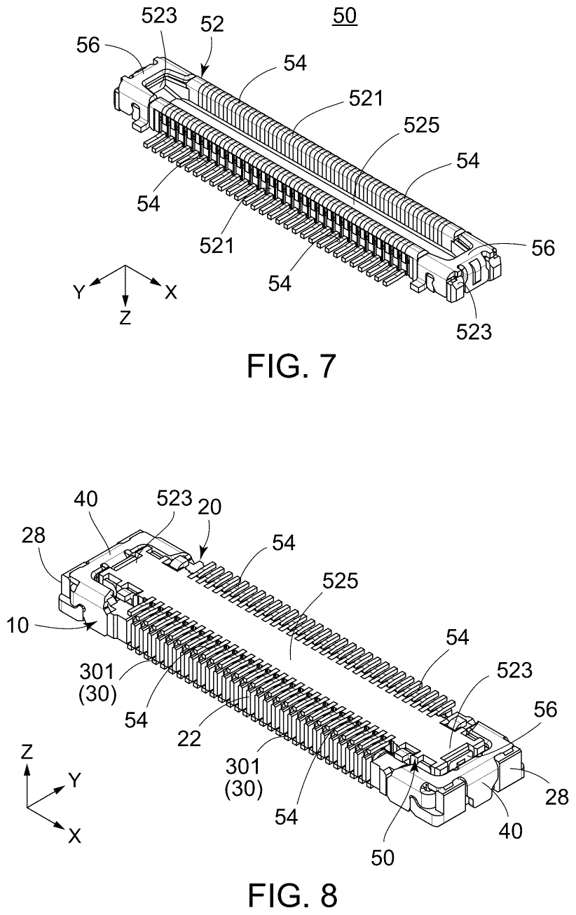

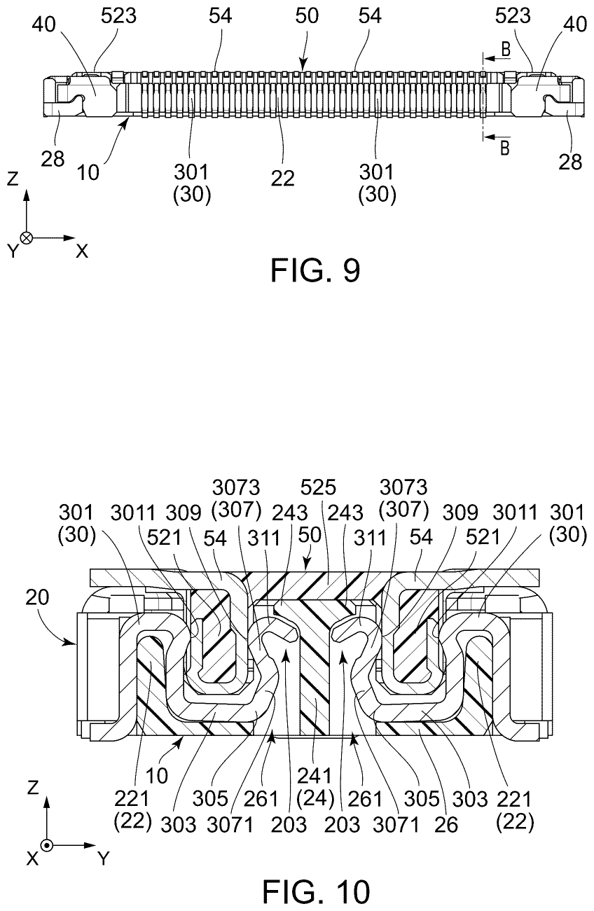

Referring to FIG. 1, a connector 10 according to a first embodiment of the present invention is provided with a housing 20, a plurality of contacts 30 and a pair of holddowns 40. The connector 10 is a socket connector and is mounted on a circuit board (not shown) when used. The connector 10 is mateable with a mating connector 50 (see FIGS. 7-10) which is positioned upward of the connector 10 in an up-down direction. In the present embodiment, the up-down direction is a Z-direction. A positive Z-direction is directed upward while a negative Z-direction is directed downward.

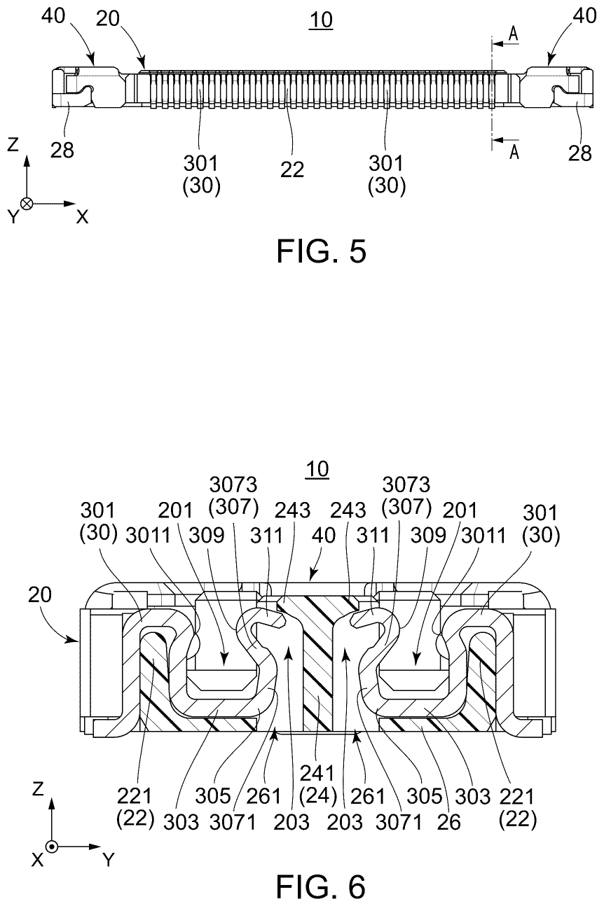

As understood from FIGS. 2 to 5, the housing 20 of the connector 10 has a pair of side portions 22, an island portion 24, a bottom portion 26 and a pair of coupling portions 28. In the present embodiment, the housing 20 is made of insulation resin, and the side portions 22, the island portion 24, the bottom portion 26 and the coupling portions 28 are integrally formed.

As shown in FIG. 2, the side portions 22 are juxtaposed in a lateral direction perpendicular to the up-down direction and extend in a front-rear direction perpendicular to both the up-down direction and the lateral direction. In the present embodiment, the lateral direction is a Y-direction, and the front-rear direction is an X-direction.

As shown in FIG. 2, the island portion 24 is situated between the side portions 22 in the lateral direction and extends in the front-rear direction. Between the island portion 24 and each of the side portions 22, a receiving portion 201 for receiving the mating connector 50 (see FIG. 7) in part is formed.

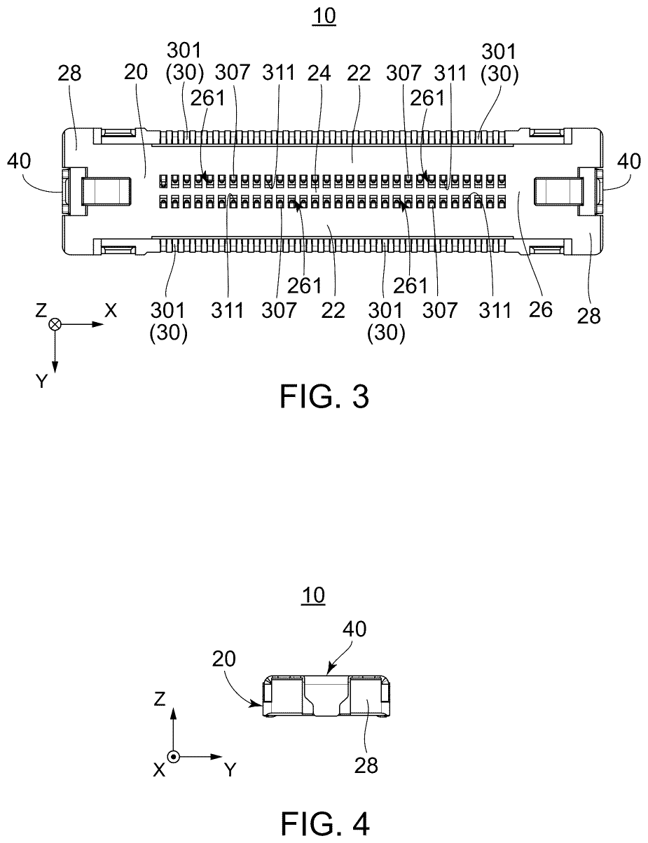

As understood from FIGS. 2 and 3, the coupling portions 28 are situated at both ends of the housing 20 in the front-rear direction. Each of the coupling portions 28 couples one of end portions of each of the side portions 22 with one of end portions of the island portion 24.

As understood from FIG. 3, the bottom portion 26 couples the side portions 22, the island portion 24 and the coupling portions 28 with one another. In other words, the side portions 22, the island portion 24 and the coupling portions 28 protrude upward from the bottom portion 26. The bottom portion 26 covers the receiving portions 201 from beneath. In other words, the receiving portions 201 are situated upward of the bottom portion 26 and open upward. The bottom portion 26 is formed with a plurality of holes 261 which pierce the bottom portion 26 in the up-down direction. The holes 261 correspond to the contacts 30, respectively. Incidentally, the holes 261 are formed when the housing 20 is formed by the use of two, i.e. upper and lower, molds. In detail, the holes 261 are marks formed by pulling out protruding portions which are provided to the lower mold to form overhangs 243 (see FIG. 6) mentioned later.

As understood from FIGS. 2 to 5, the holddowns 40 correspond to the coupling portions 28, respectively. Each of the holddowns 40 is made from a sheet metal and attached to the coupling portions 28 corresponding thereto.

As shown in FIG. 2, the contacts 30 are arranged in two rows. The two contact rows are juxtaposed in the lateral direction. In each of the contact rows, the contacts 30 are arranged in the front-rear direction at predetermined intervals. Each of the contacts 30 in one of the contact rows is juxtaposed with any one of the contacts 30 in the other one of the contact rows in the lateral direction.

Referring to FIG. 6, two of the contacts 30 adjacent to each other in the lateral direction are arranged to be mirror images of each other with respect to a plane perpendicular to the lateral direction. Each of the contacts 30 has a held portion 301, a lower end portion 303, a bent portion 305, a supporting portion 307, a contact point 309 and a tip portion 311. Each of the contacts 30 is formed by, for example, stamping and bending a metal sheet.

As shown in FIG. 6, the held portion 301 of the contact 30 extends inward in the lateral direction from one of end portions thereof, then extends upward, then further extends inward in the lateral direction, and is bent downward to extend outward in the lateral direction and then still further extends downward. The lower end portion 303 is connected to a remaining one of the end portions of the held portion 301 at one of end portions thereof and extends inward in the lateral direction to a remaining one of the end portions thereof from the held portion 301. The bent portion 305 is provided at a remaining one of the end portions of the lower end portion 303 and connects the remaining one of the end portions of the lower end portion 303 to one of end portions of the supporting portion 307. The supporting portion 307 extends upward from the bent portion 305. A remaining one of the end portions of the supporting portion 307 is provided with the contact point 309. In other words, the contact point 309 is supported by the supporting portion 307. The contact point 309 is a part of a surface of the contact 30 and faces with, in the lateral direction, a facing portion 3011 which is provided on the held portion 301. In the present embodiment, the facing portion 3011 is a part of a surface of the held portion 301. The tip portion 311 extends upward from the contact point 309, then is bent inward in the lateral direction, and then extends obliquely downward.

As understood from FIG. 6, the contacts 30 are held by the side portions 22 of the housing 20. Thus, each of the side portions 22 of the housing 20 has holding portions 221 for holding the held portions 301 of the contacts 30, and the held portions 301 are held by the holding portions 221, respectively. Incidentally, each of the holding portions 221 has a part identical with the held portion 301 when viewed along the front-rear direction, the part is situated at each side of the held portion 301 in the front-rear direction.

As shown in FIG. 6, the island portion 24 of the housing 20 has a sectional shape of a generally T-shape. In detail, the island portion 24 is provided with a wall portion 241 and the overhangs 243 which protrude, in the lateral direction, outward from an upper end of the wall portion 241. Each of the overhangs 243 has a lower surface, and the lower surface extends in a direction intersecting with the up-down direction. Under the overhangs 243, there exist allowing portions 203 continuous to the receiving portions 201, respectively. The allowing portions 203 are spaces for allowing partial movement of the contacts 30 in the lateral direction when the connector 10 and the mating connector 50 are mated with each other. Thus, the housing 20 is formed with the allowing portions 203 continuous to the receiving portions 201 in the lateral direction.

As shown in FIG. 6, in a state where the contacts 30 are held by the housing 20, each of the contacts 30 is situated in any one of the receiving portions 201 of the housing 20 in part. In detail, at least the lower end portion 303 and the bent portion 305 of the contact 30 are situated in the receiving portion 201. In the present embodiment, the supporting portion 307 is also situated in the receiving portion 201. In addition, the tip portion 311 of the contact 30 is situated outside the receiving portion 201 at least in part, i.e. in the allowing portions 203 at least in part. In the present embodiment, the supporting portion 307 is not situated in the allowing portion 203. With this structure, at least the lower end portion 303 and the bent portion 305 do not need to be resiliently deformed when the contact 30 is attached to the housing 20.

As understood from FIG. 6, the supporting portion 307 of the contact 30 is resiliently deformable, and the contact point 309 is movable at least in the lateral direction. Moreover, due to resilient deformation of the supporting portion 307, the tip portion 311 of the contact 30 is movable at least in the lateral direction.

As understood from FIG. 6, upward movement of the tip portion 311 of the contact 30 is suppressed by the overhang 243 of the island portion 24. In other words, the overhang 243 serves as a movement suppression portion 243 which suppresses the movement of the tip portion 311 of the contact 30. Thus, the housing 20 has the movement suppression portions 243 which suppress the movement of the tip portions 311 of the contacts 30. The movement suppression portions 243 extend toward the receiving portions 201 over the allowing portions 203, respectively.

As shown in FIG. 6, in the present embodiment, the supporting portion 307 of the contact 30 has a first linear portion 3071 and a second linear portion 3073. The first linear portion 3071 extends obliquely upward from the bent portion 305 toward the movement suppression portion 243. The second linear portion 3073 extends obliquely upward from the first linear portion 3071 but away from the movement suppression portion 243 in the lateral direction. In addition, when the connector 10 is viewed along the up-down direction, the tip portion 311 of the contact 30 is hidden by the movement suppression portion 243 at least in part. However, the present invention is not limited thereto. A shape of the supporting portion 307 may be freely set, provided that the supporting portion 307 holds the contact point 309 so that the contact point 309 is situated in the receiving portion 201 and movable at least in the lateral direction. For example, the supporting portion 307 may linearly extend from the bent portion 305 to the contact point 309. Nevertheless, when the supporting portion 307 has the first linear portion 3071 and the second linear portion 3073, a spring length thereof can be longer than that in a case that the supporting portion 307 has a linear shape.

As understood from FIGS. 6 and 10, when the connector 10 and the mating connector 50 are mated with each other, the lower end portion 303 of the contact 30 could be moved downward. The bottom portion 26 of the housing 20 suppresses the downward movement of the lower end portion 303 and prevents the contacts 30 from being deformed. Thus, the bottom portion 26 of the housing 20 serves as a deformation prevention portion which prevents the contacts 30 from being deformed. The deformation prevention portion prevents not only the contacts 30 from being deformed but also the contact 30 from being in contact with a substrate (not shown) on which the connector 10 is mounted. Moreover, when the connector 10 is mounted on the substrate (not shown), foreign bodies can be prevented from entering the allowing portions 203. For example, when the connector 10 is glued to the substrate, adhesion of glue to the contact 30 in the allowing portion 203 can be suppressed, and reliability of contact between the contact 30 and a mating contact 54 (see FIG. 7) can be maintained.

Referring to FIG. 7, the mating connector 50 has a mating housing 52, a plurality of mating contacts 54 and a pair of mating holddowns 56. The mating connector 50 is a plug connector and mateable with the connector 10 of FIG. 1.

As understood from FIG. 7, the mating housing 52 has a pair of mating side portions 521, a pair of mating coupling portions 523 and a mating bottom portion 525. In the present embodiment, the mating housing 52 is made of insulating resin, and the mating side portions 521, the mating coupling portions 523 and the mating bottom portion 525 are integrally formed.

As shown in FIG. 7, the mating side portions 521 are juxtaposed in the lateral direction and extend in the front-rear direction. Each of the mating coupling portions 523 couples ones of end portions of the mating side portions 521 to each other. Each of the mating holddowns 56 is made of a sheet metal, and the mating holddowns 56 correspond to the mating coupling portions 523, respectively. Each of the mating holddowns 56 is attached to the coupling portion 28 corresponding thereto.

As understood from FIG. 7, the mating contacts 54 are arranged into two rows and held by the mating side portions 521. The mating contacts 54 correspond to the contacts 30 of the connector 10.

As shown in FIGS. 8 to 10, the connector 10 and the mating connector 50 are mateable with each other. In a mated state, the mating side portions 521 of the mating connector 50 are received, in part, by the receiving portions 201 of the connector 10. At that time, the mating contact 54 is inserted between the contact point 309 and the facing portion 3011 of the contact 30 corresponding thereto. Thus, the contact 30 and the mating contact 54 corresponding to the contact 30 are electrically connected to each other. In the mated state, the supporting portion 307 of the contact 30 is situated, in part, in the allowing portion 203, and the tip portion 311 extends obliquely downward. The tip portion 311 extends obliquely downward, so that a contact area between the tip portion 311 and the overhang 243 can be relatively wide if the tip portion 311 is moved upward when the mating connector 50 is removed from the connector 10. Accordingly, concentration of a force added from the tip portion 311 to the overhang 243 can be avoided, and damage to the overhang 243 can be prevented.

The description will be made below about a method for manufacturing the connector 10.

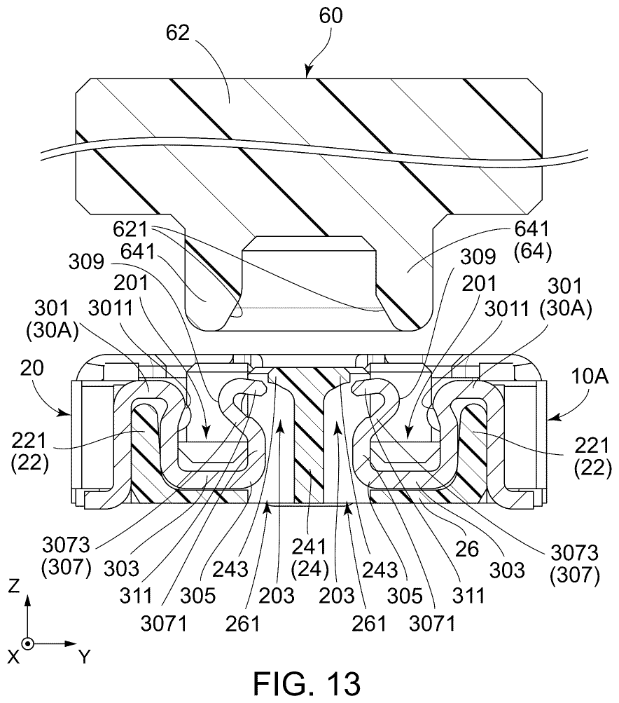

First, the housing 20 (see FIGS. 1 to 6) and contact intermediate products 30A (see FIG. 13) are provided. As understood from comparison between FIG. 6 and FIG. 13, each of the contact intermediate product 30A is slightly different from the contact 30 in shape. The contact intermediate product 30A can be transformed into the contact 30 by plastically deforming it. Although the contact intermediate product 30A is different from the contact 30 in shape, it is common with the contact 30 in a point that it has a held portion 301, a lower end portion 303, a bent portion 305, a supporting portion 307, a contact point 309 and a tip portion 311.

Next, as shown in FIG. 13, the held portion 301 of the contact intermediate product 30A is held by the holding portion 221 of the housing 20, so that the contact intermediate products 30A is attached to the housing 20. This attachment is carried out by positioning the contact intermediate products 30A above the housing 20, followed by moving the contact intermediate products 30A downward. For example, the held portion 301 of the contact intermediate product 30A is press-fitted into the holding portion 221 of the housing 20. Here, the contact intermediate product 30A is formed so that at least the lower end portion 303 and the bent portion 305 can be received by the receiving portion 201 without resiliently and plastically deforming at least the lower end portion 303 and the bent portion 305. In the present embodiment, the contact intermediate product 30A is formed so that a part from the lower end portion 303 to the tip portion 311 can be received by the receiving portion 201 without resiliently and plastically deforming it.

As shown in FIG. 13, in a connector intermediate product 10A in which the contact intermediate products 30A are attached to the housing 20, each of the contact intermediate products 30A does not enter the allowing portion 203 corresponding thereto. This means that attachment of the contact intermediate products 30A to the housing 20 can be carried out without intentional, resilient and plastic deformation of the contact intermediate products 30A.

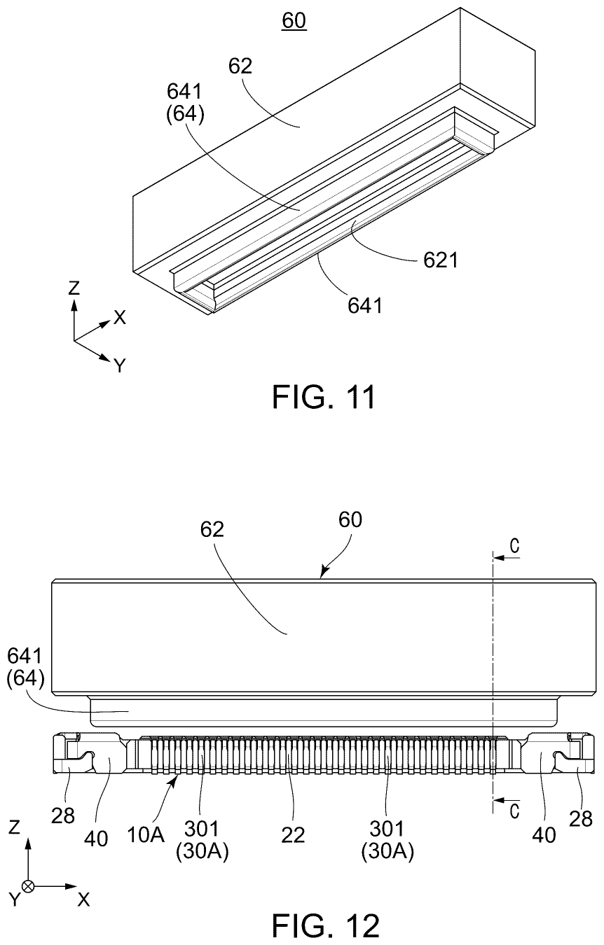

Next, a jig 60 shown in FIG. 11 is prepared. The jig 60 is provided with a base 62 and an insert portion 64 protruding downward from a lower surface of the base 62. The insert portion 64 has a frame shape long in the front-rear direction when viewed along the up-down direction. The shape of the insert portion 64 is based on the shape of the mating connector 50 (see FIG. 7) and insertable into the receiving portions 201 of the housing 20 at least in part. The insert portion 64 has long ridge portions 641 corresponding to the receiving portions 201, respectively.

As shown in FIG. 13, the insert portion 64 of the jig 60 has a tapered shape. In the present embodiment, the long ridge portions 641 of the insert portion 64 is formed with inclined surfaces 621 on inner sides thereof in the lateral direction. The inclined surfaces 621 are directed inward in the lateral direction and downward in the up-down direction. Each of the inclined surfaces 621 guides the insert portion 64 between the contact points 309 and the facing portions 3011 in each of the receiving portions 201 when the insert portion 64 is inserted into the receiving portions 201 of the housing 20. This is for preventing that the insert portion 64 is brought into abutment with the tip portion 311 of the contact intermediate product 30A and buckles the supporting portion 307 of the contact intermediate product 30A.

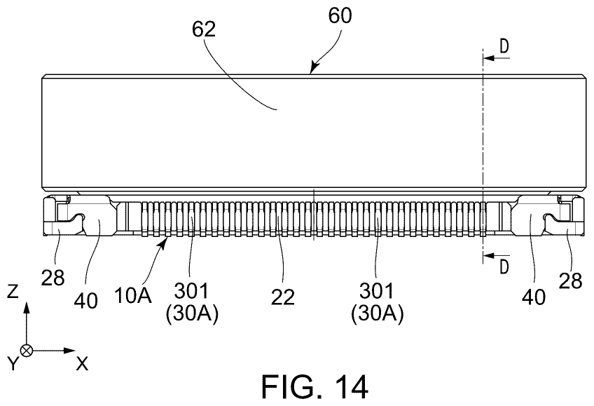

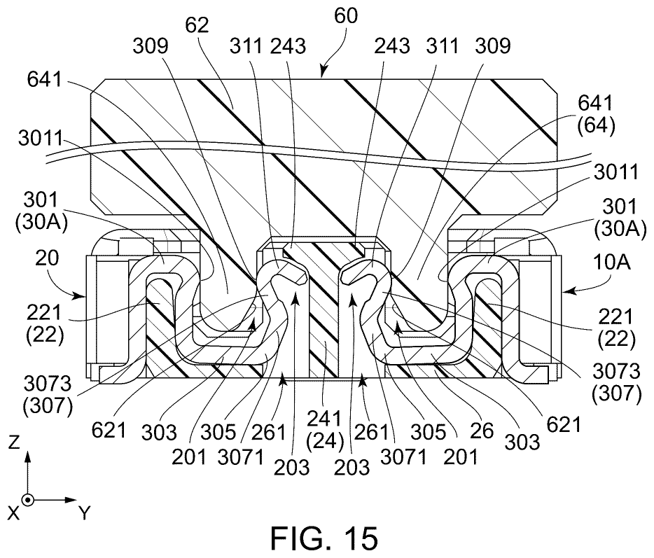

Next, as shown in FIG. 13, the prepared jig 60 is disposed above the connector intermediate product 10A. Then, as understood from FIGS. 12 to 15, the jig 60 is moved toward the connector intermediate product 10A, and the long ridge portions 641 of the insert portion 64 of the jig 60 is inserted into the receiving portions 201 of the housing 20. At that time, each of the long ridge portions 641 of the insert portion 64 of the jig 60 which is inserted into the receiving portion 201 corresponding thereto is inserted between the contact points 309 of the contact intermediate products 30A and the facing portions 3011 of the held portion 301 in each of the receiving portions 201. If suitable setting is made for a shape and a size of each of the contact intermediate products 30A and a shape and a size of the insert portion 64, insertion of the insert portion 64 of the jig 60 plastically deforms the contact intermediate product 30A. This plastic deformation is carried out so that an interval between the contact point 309 of the contact intermediate product 30A and the facing portion 3011 of the contact intermediate product 30A is increased. In addition, the plastic deformation is carried out so that the tip portion 311 of the contact intermediate product 30A is situated, at least in part, under the overhang 243 which is the movement suppression portions 243. The plastic deformation is mainly caused on the bent portion 305. However, the bent portion 305 is still situated in the receiving portion 201 after the plastic deformation.

After that, the jig 60 is detached from the housing 20. In a case where elastic deformation is caused on the contact intermediate product 30A in addition to the plastic deformation, the elastic deformation is removed by detachment of the jig 60. Even when the elastic deformation is removed, the tip portion 311 of the contact intermediate product 30A is situated under the overhang 243 at least in part, and the tip portion 311 is hidden by the overhang 243 when viewed along the up-down direction. Moreover, the lower end portion 303 and the bent portion 305 of the contact intermediate product 30A are still situated in the receiving portion 201. Thus, the contact intermediate product 30A forms the contact 30 after the plastic deformation step.

As mentioned above, according to the aforementioned method for manufacturing the connector 10, intentional, elastic deformation of the contact intermediate product 30A is not necessary when the contact intermediate product 30A is attached to the housing 20. Accordingly, the contact intermediate product 30A does not need a high elastic limit, so that the contact 30 can be downsized. In addition, the contact 30 can be downsized, so that the connector 10 can be downsized.

### Second Embodiment

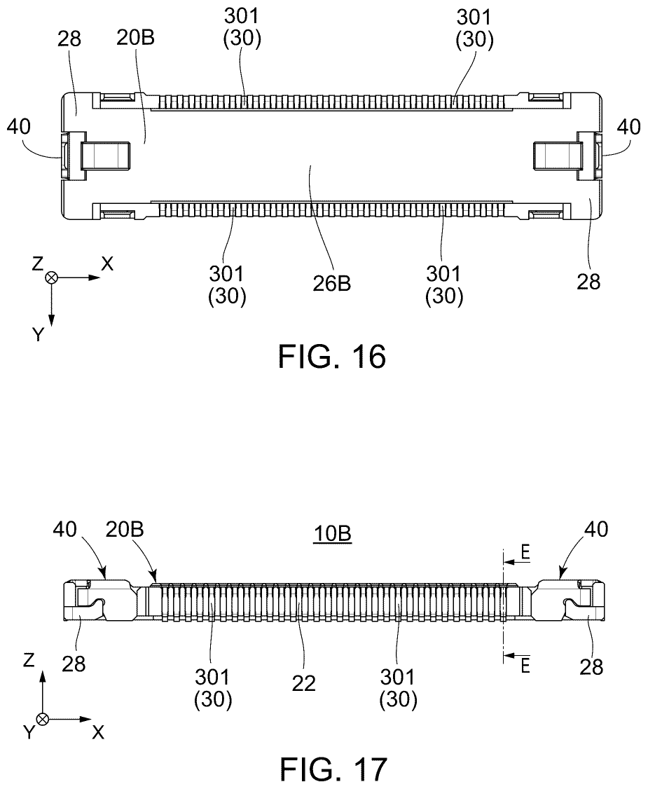

Referring to FIGS. 16 to 18, a connector 10B according to a second embodiment of the present invention is same as the connector 10 except for a point that a bottom portion 26B of a housing 20B is not formed with the holes 261 (see FIG. 3).

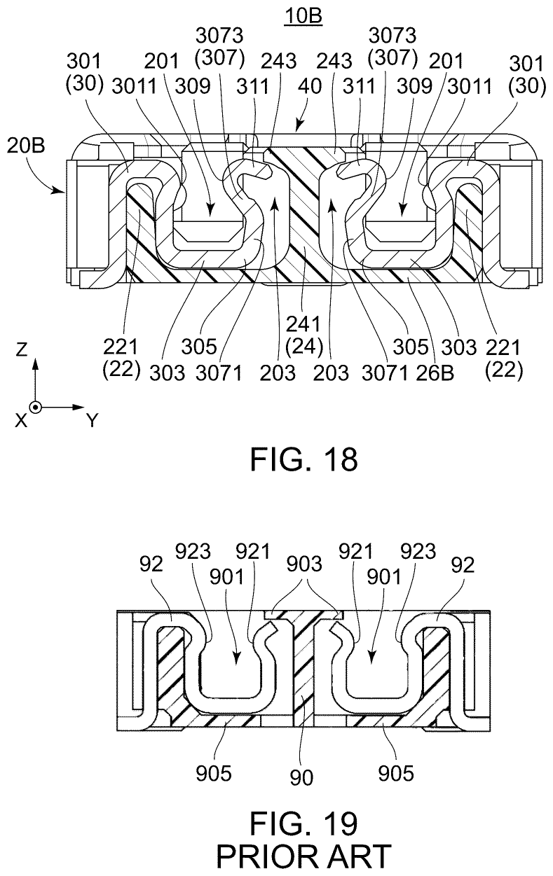

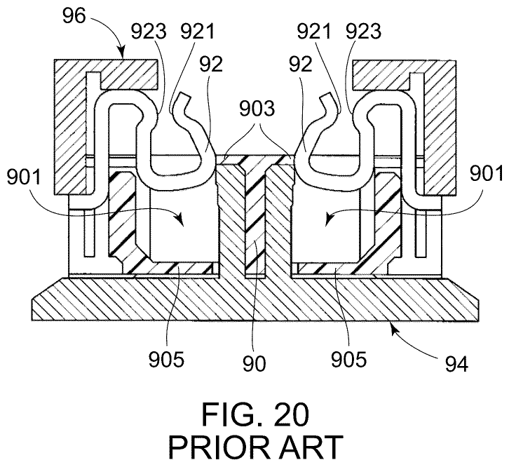

As understood from FIGS. 16 and 18, in the connector 10B, the bottom portion 26B of the housing 20B covers not only receiving portions 201 but also allowing portions 203. With this structure, when the connector 10B is mounted on a substrate (not shown), foreign bodies are prevented from entering the allowing portions 203. For example, when glue is filled between the connector 10B and the substrate, adhesion of the glue to the contact 30 in the allowing portion 203 is prevented, and reliability of contact between the contact 30 and a mating contact 54 (see FIG. 7) can be maintained. However, formation of the housing 20B needs inserts for forming the overhangs 243 in addition to upper and lower molds. Accordingly, formation of the housing 20 is easier than that of the housing 20B.

Although the specific explanation about the present invention is made above with reference to the embodiments, the present invention is not limited thereto but susceptible of various modifications and alternative forms without departing from the spirit of the invention. For example, although the contacts 30 are arranged in two rows in each of the aforementioned embodiments, the contacts 30 may be arranged in a single row. Moreover, the number of the contacts 30 may be freely set. In addition, the shape of the housing 20 is not particularly limited.

While there has been described what is believed to be the preferred embodiment of the invention, those skilled in the art will recognize that other and further modifications may be made thereto without departing from the spirit of the invention, and it is intended to claim all such embodiments that fall within the true scope of the invention.

What is claimed is:

1. A method for manufacturing a connector which is mateable with a mating connector positioned upward of the connector in an up-down direction, wherein:
the method comprises preparing a housing and a contact intermediate product;
the housing has a holding portion, a bottom portion and a movement suppression portion;
the housing is formed with a receiving portion which is situated upward of the bottom portion and opens upward and an allowing portion communicating with the receiving portion in a lateral direction perpendicular to the up-down direction;
the movement suppression portion extends toward the receiving portion over the allowing portion;
the contact intermediate product has a held portion, a lower end portion extending from the held portion, a bent portion provided at one end of the lower end portion, a supporting portion extending from the bent portion, a contact point supported by the supporting portion and a tip portion extending from the contact point;
the contact point faces a facing portion provided on the held portion in the lateral direction;
the method further comprises making the holding portion of the housing hold the held portion of the contact intermediate product to attach the contact intermediate product to the housing;
in a state where the contact intermediate product is attached to the housing, the contact intermediate product does not enter the allowing portion;
the method further comprises inserting a jig between the contact point and the facing portion of the held portion and thereby causing plastic deformation of the contact intermediate product to form a contact; and
after the plastic deformation, the tip portion is situated in the allowing portion at least in part and hidden by the movement suppression portion at least in part when viewed along the up-down direction.

2. A connector which is mateable with a mating connector positioned upward of the connector in an up-down direction, wherein:
the connector comprises a housing and a contact;
the housing has a holding portion, a bottom portion and a movement suppression portion;
the housing is formed with a receiving portion which is situated upward of the bottom portion and opens upward and an allowing portion communicating with the receiving portion in a lateral direction perpendicular to the up-down direction;
the movement suppression portion extends toward the receiving portion over the allowing portion;
the contact has a held portion, a lower end portion extending from the held portion, a bent portion provided at one end of the lower end portion, a supporting portion extending from the bent portion, a contact point supported by the supporting portion and a tip portion extending from the contact point;
the held portion is held by the holding portion;
the lower end portion and the bent portion are situated in the receiving portion; and
the tip portion is situated in the allowing portion at least in part and hidden by the movement suppression portion at least in part when viewed along the up-down direction.

3. The connector as recited in claim 2, wherein the supporting portion is situated in the receiving portion but not situated in the allowing portion.

4. The connector as recited in claim 2, wherein the supporting portion has a first linear portion extending obliquely upward from the bent portion toward the movement suppression portion and a second linear portion extending obliquely upward from the first linear portion but away from the movement suppression portion in the lateral direction.

5. The connector as recited in claim 2, wherein:
the movement suppression portion has a lower surface extending in a direction intersecting with the up-down direction; and
in a mated state where the mating connector and the connector are mated with each other, the tip portion extends in an obliquely downward direction.

6. The connector as recited in claim 2, wherein the bottom portion has no hole.
